(19) United States
(12) Patent Application Publication
(10) Pub. No.: US 2022/0121076 A1
(43) Pub. Date: Apr. 21, 2022

(54) GLAZING UNIT AND METHOD FOR PRODUCING SAME

(71) Applicant: SAINT-GOBAIN GLASS FRANCE, COURBEVOIE (FR)

(72) Inventors: Marcus NEANDER, ESCHWEILER (DE); Bianca BERGS, GANGELT (DE)

(21) Appl. No.: 17/428,887

(22) PCT Filed: Feb. 19, 2020
(86) PCT No.: PCT/EP2020/054337

§ 371 Date: Aug. 5, 2021

(30) Foreign Application Priority Data
Feb. 27, 2019 (EP) 19159554.5

(51) Int. Cl. G02F 1/155; B60S 1/02; B60J 1/00; B32B 17/10; C03C 17/23

(52) U.S. Cl. CPC G02F 1/155; B60S 1/026; B60J 1/001; B60J 1/002; B32B 17/10055; E06B 3/6722; B32B 17/10302; B32B 17/10513; B32B 17/10807; C03C 17/23; G02F 2203/01; B32B 17/10174

(57) ABSTRACT

A glazing unit includes at least one first and second glass or plastic pane that are joined to one another at a predetermined distance via a spacer or a thermoplastic intermediate layer, wherein at least one of the first and second glass or plastic pane includes, on the inner side of the glazing unit, a transparent electrically conductive coating and, in an edge region thereof, a bus bar for the electrical connection of the conductive coating, wherein the bus bar is provided, at least over the greater part of its surface, with an opaque covering.

The invention relates to a glazing unit that has at least one first and second glass or plastic pane that are joined to one another at a predetermined distance via a spacer or a thermoplastic intermediate layer, wherein at least one of the first and second glass or plastic pane includes, on the inner side of the glazing unit, a transparent electrically conductive coating and, in particular in an edge region thereof, a bus bar for the electrical connection of the conductive coating. It further relates to a method for producing such a glazing unit.

Glazings are a functionally essential and aesthetically significant part of buildings and vehicles, in particular of road vehicles, but are also occasionally used in household appliances or pieces of furniture or similar objects. Conventionally, their purpose consists in ensuring natural lighting of the interior and simultaneously (in buildings and vehicles) a view from them into the surroundings. Due to increased demands of users and, at the same time, made possible by novel technologies, glazings that implement additional protection and comfort functions are increasingly being developed and produced.

In addition to glazing units with a wide variety of functional coatings, for instance, for the selective absorption of certain radiation components of sunlight or for reducing heat radiation to the outside, glazing units with controllable functions are also increasingly gaining significance. Whereas glazing units with heatable panes have been known for a long time and have even been in practical use to a limited extent, glazing units with electrochromic properties or those with electrically controllable liquid crystal layers for selective control of transmittance have become more widespread in recent years.

In modern developments of this type, at least one of the glass or plastic panes has a partial or even a full-surface transparent electrically conductive coating via which a voltage is applied to an electro-optically active layer and which serves as a control electrode for controlling the optical properties. These coatings contain at least a metal, a metal alloy, or a transparent conductive oxides (TCO). For example, the surface electrodes can contain silver, gold, copper, nickel, chromium, and/or tungsten or indium tin oxide (ITO), gallium-doped or aluminum-doped or otherwise doped tin oxide. In the interest of the highest possible transparency of the pane, they have to be very thin and preferably have a thickness in the range between 10 nm and 2 μm.

Due to the low thickness, the coatings are not suitable for direct connection to an electrical supply line, for instance, by soldering. Consequently, in practice, a bus bar is used to connect to an electrical supply line. The bus bar is, for example, strip-shaped or wire-shaped. The bus bar is made of an electrically conductive material, such as silver, copper, copper alloy, or aluminum. It can be produced, for example, by printing a conductive paste, in particular a silver paste, on the electrically conductive and/or electrically switchable coating for electrical contacting. The conductive silver paste contains silver particles and, optionally, glass frits.

US 2014/0247475 A1 and US 2014/0133005 A1 disclose glazing units that have an electrochromic layer and a bus bar arranged at least partially thereon.

WO 2014/019780 A1 and WO 2012/004280 A1 disclose composite panes with an electrically heatable coating and bus bars arranged thereon.

The conductive paste for forming the bus bars is often applied to the corresponding pane with relatively simple means and then converted into a essentially metallic thick layer by thermal treatment (sintering). Both during application and during the thermal treatment, aesthetic aspects cannot be readily counted on such that the bus bars of the corresponding glazing units are often not very attractive. Bus bars implemented as metal strips or metal wires are also often not very attractive. If the bus bars are not subsequently covered by an appropriate frame construction, this adversely affects the aesthetic appearance of the glazing unit.

The object of the invention is, consequently, to specify a glazing unit that is improved both aesthetically and, in particular, functionally and a method for its production that can be carried out simply and economically.

This object is accomplished in its product aspect by a glazing unit with the features of claim 1 and in its method aspect by a method with the features of claim 13. Expedient further developments are the subject matter of the dependent claims. The invention includes the idea of retaining the bus bar configuration of the generic glazing units that is aesthetically unsatisfactory, but improving the appearance by means of an additional element or an additional manufacturing step. Specifically, provision is made for the bus bar to be provided with an opaque covering, at least over the greater part of its surface.

The invention relates to a glazing unit that has at least one first and second glass or plastic pane that are joined to one another at a predetermined distance via a spacer or a thermoplastic intermediate layer, wherein at least one of the first and second glass or plastic pane includes, on the inner side of the glazing unit, a transparent electrically conductive coating, and, in an edge region thereof, a bus bar for the electrical connection of the conductive coating, wherein the bus bar is provided, at least over the greater part of its surface, with an opaque covering.

This transparent conductive coating can, for example, contain at least a metal, a metal alloy, or a transparent conductive oxide (TCO). For example, the surface electrodes can contain silver, gold, copper, nickel, chromium, and/or tungsten or indium tin oxide (ITO), gallium-doped or aluminum-doped or otherwise doped tin oxide.

Particularly suitable transparent, electrically conductive coatings contain at least a metal, preferably silver, nickel, chromium, niobium, tin, titanium, copper, palladium, zinc, gold, cadmium, aluminum, silicon, tungsten, or alloys thereof, and/or at least a metal oxide layer, preferably tin-doped indium oxide (ITO), aluminum-doped zinc oxide (AZO), fluorine-doped tin oxide (FTO, SnO2:F), antimony-doped tin oxide (ATO, SnO2:Sb), and/orcarbon nanotubes and/or optically transparent, electrically conductive polymers, preferably poly(3,4-ethylene dioxythiophene), polystyrene sulfonate, poly(4,4-dioctylcylopentadithiophene), 2,3-dichloro-5,6-dicyano-1,4-benzoquinone, mixtures, and/or copolymers thereof.

In the interest of the highest possible transparency of the pane, the electrically conductive coatings are very thin and preferably have a thickness in the range between 10 nm and 5 μm and particularly preferably between 30 nm and 1 μm. The sheet resistance of the transparent, electrically conductive coating is, for example, 0.35 ohm/square to 200 ohm/square, preferably 0.6 ohm/square to 30 ohm/square, and in particular from 2 ohm/square to 20 ohm/square.

In the glazing unit according to the invention, the bus bar for the electrical connection of the conductive coating is, for example, ribbon-shaped or wire-shaped. The bus bar is made of an electrically conductive material, such as silver, copper, copper alloy, or aluminum. It can, for example, be produced by printing a conductive paste, in particular a silver paste, on the electrically conductive and/or electrically switchable coating for electrical contacting. The conductive silver paste contains silver particles and, optionally, glass frits. The layer thickness of the baked conductive paste is, for example, approx. 5 μm to 20 μm.

The bus bar can also be formed from metal foil strips or metal wires that contain or are formed from copper, a copper alloy, or aluminum. The metal foil strips or metal wires can be applied to the electrically conductive and/or electrically switchable coating by means of an electrically conductive adhesive.

The proposed opaque covering eliminates the aesthetic deficits of known glazing units, but can, at the same time, provide additional protection of the bus bar against corrosion or mechanical influences. Its manufacture is simple and economical with known and readily available auxiliary means and can be flexibly adapted to the specific structure and the use conditions of a correspondingly designed glazing unit.

Here, the term “covering” means any form of extensive covering of the bus bars that are in need of aesthetic improvement and/or additional protection with a suitable means. In particular, this can be a commercially available adhesive tape (black or colored depending on the application situation), a coating with a highly pigmented lacquer or some other application of paint, or, optionally, even a more or less self-supporting cover strip or cover profile.

The opaque covering is preferably an electrically nonconductive, opaque covering.

In one embodiment of the glazing unit according to the invention, the opaque covering has a paint or lacquer layer, wherein this paint or lacquer layer is preferably a paint or lacquer layer that does not have to be baked.

The covering of the bus bar is arranged in the line of vision toward the interior of the glazing unit. Thus, according to the invention, the covering is not arranged between the bus bar and the electrically conductive coating.

According to the invention, the covering of the bus bar is arranged in the region in which it covers the bus bar directly adjacent the bus bar. Thus, in this region, there are no further layers situated between the covering and the bus bar.

In other embodiments, the bus bar is elongated and arranged at or near an edge of the glass or plastic pane and extends parallel to the edge, and the opaque covering extends substantially over the entire length of the edge. Alternatively, the covering can also be implemented such that it covers only a portion of the edge region, and this partial covering can also be configured to be visually appealing.

Specifically, vehicle windows, but also building windows in special embodiments, can have curved edges. Accordingly, the corresponding outer edges of the transparent conductive coverings are usually also curved, and bus bars arranged there as well can have a non-rectilinear course. In the implementation of the invention, the opaque covering can then be adapted to the curved course of the bus bar and the edge course of the glazing unit. It is also possible for bus bars to be provided in corner regions of a glazing unit and to have an angular shape, and, in that case, it makes sense to select the geometric configuration of the covering accordingly.

Furthermore, provision can be made for the bus bar to be arranged at a distance from the edge of the glass or plastic pane but for the opaque covering to extend all the way to the edge of the glass or plastic pane. Alternatively, however, it is also possible, for certain applications, not to provide the immediate edge region of the glazing unit with the proposed covering, for example, in order not to adversely affect the edge seal provided there in terms of its functionality and performance parameters.

In a preferred embodiment of the glazing unit according to the invention, the first and second glass or plastic pane are joined to one another and kept at a distance from one another by an edge spacer device with a spacer element and, in each case, a sealing strip between the spacer element and the first and second glass or plastic pane, and the bus bar is arranged to the inside of the spacer device.

When the first and second glass or plastic pane are joined to one another and kept at a distance by an edge spacer device with a spacer element and, in each case, a sealing strip between the spacer element and the first and second glass or plastic pane, and the bus bar is arranged to the inside of the spacer device, and the opaque covering covers a pane portion that contacts one of the sealing strips, care must be taken that the covering is made from a material compatible with the material of the sealing strip. The specific material selection can sensitively depend on the materials and the production of the edge seal such that no general statements can be made in this regard.

The expression “an arrangement to the inside of the spacer device” means that the bus bar is arranged at a distance from the spacer device in the pane interior on the electrically conductive coating.

Glazing units of the generic type can be provided with electro-optical functional elements that include a plurality of separately controllable sections. Here, in particular, isolating lines can be introduced into the conductive coating (surface electrode) such that the coating is divided into segments isolated from one another.

These segments then have separate bus bars in each case. Accordingly, when implementing the invention, the opaque covering can also be segmented on one or more side edges of the glazing unit. However, from the point of view of the inventors, it is preferable to provide a continuous opaque covering for multiple bus bars, because such a cover is easier to produce and is generally also more appealing visually.

In a practically significant embodiment category, the glazing unit is a building glazing unit with electrically controllable properties, for instance, electrochromic properties for selective coloring, or also with an LCD functional layer for selective control of transparency or opacity.

Composite vehicle panes, in particular roof glazings or windshields of passenger cars with electrically controllable properties, are another important embodiment category of the proposed glazing unit. Such vehicle glazings can also be equipped with electrochromic properties or with LCD functional layers, and the latter can be specifically provided only in a portion of the respective glazing unit (for instance, as a sunvisor section).

The invention is, moreover, also usable in building or vehicle glazing units that are provided with a transparent heating conductor layer or transparent heating conductor tracks for heating purposes.

And finally, the invention can also be used in glazing units for certain technical devices, such as high-end refrigerators or other household appliances, or container furniture, such as bar cabinets, where heating is to be implemented to prevent fogging or to control optical properties for other reasons.

The invention also relates to a method for producing the glazing units according to the invention, at least comprising the following steps:
Providing a first and a second glass or plastic pane, wherein at least one of the first and second glass or plastic pane includes, on one side, a transparent electrically conductive coating,
Producing or applying a bus bar on the transparent electrically conductive coating in the edge region thereof,
Attaching a supply line on the bus bar,
Providing the greater part of the surface of the bus bar with an electrically nonconductive, opaque covering.

In the method according to the invention, the last two steps mentioned can be carried out in any order.

It goes without saying that when providing the first and the second glass or plastic pane, wherein at least one of the first and second glass or plastic pane includes, on one side, a transparent electrically conductive coating, the electrically conductive coating is applied on one side which is, in the glazing unit according to the invention, an inner side.

Thus, the glazing unit according to the invention can be produced according to a method wherein after providing the glass or plastic pane with a transparent electrically conductive coating, the bus bar is produced or applied on the conductive coating and a supply line is soldered or conductively bonded thereon, and, after that, the bus bar is provided with the opaque covering, with simultaneous covering of the soldering or bonding point.

Alternatively, the glazing unit according to the invention can be produced according to a method wherein, after providing the glass or plastic pane with a transparent electrically conductive coating, the bus bar is produced or applied on the conductive coating, then, the bus bar is provided with the opaque covering leaving open an intended soldering or bonding point, and, after that, a supply line is soldered or conductively bonded onto the bus bar at the soldering or bonding point.

With regard to the proposed methods, it should be noted that application of the opaque covering after completion of the steps necessary for the electrical connection of the surface electrodes on the pane or the panes is preferred, if the best possible aesthetic and protective effect of the covering is to be achieved. In this embodiment, the use of an adhesive tape or of a prefabricated covering strip or profile (optionally with an adhesive coating) is appropriate. The alternative procedure, in which the covering of the bus bar(s) is applied before soldering or bonding the supply line is currently considered less preferable optically and functionally, but can possibly be integrated into the manufacturing sequence of the glazing unit better and more economically. This is true particularly if the opaque covering is realized using a coating device for applying a layer that is initially liquid or pasty.

It goes without saying that with regard to preferred embodiments, the statements made above concerning the glazing unit according to the invention apply equally to the methods according to the invention.

The various embodiments of the invention can be realized individually or in any combinations. In particular, the features mentioned above and explained in the following can be used not only in the combinations indicated, but also in other combinations or in isolation, without departing from the scope of the present invention.

Advantages and functionalities of the invention are also evident from the following description of exemplary embodiments and aspects of the invention with reference to the drawings. The drawings are schematic representations and are not to scale and in no way restrict the invention. They depict:

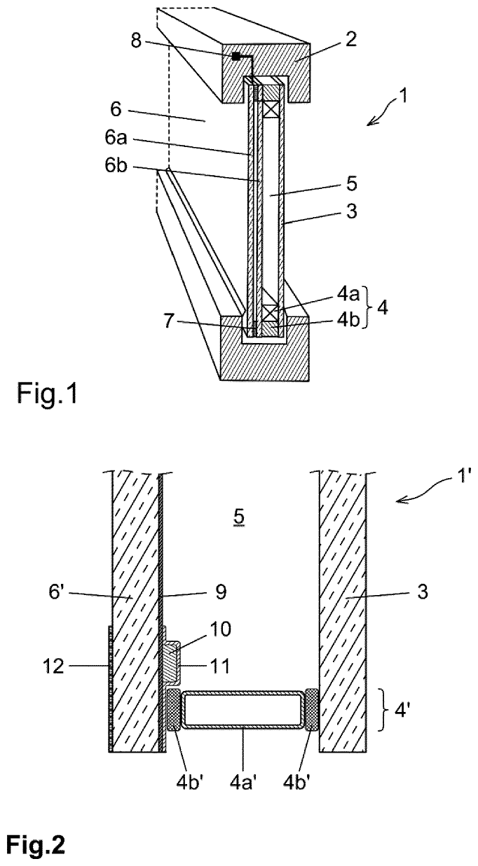

FIG. 1 a schematic representation of a generic glazing unit in a perspective sectional view, and

FIG. 2 a sectional view (detailed representation) of one embodiment of the glazing unit according to the invention.

FIG. 1 depicts a glazing unit 1 having electrochromic properties, as a building glazing unit inserted into a window frame 2. The glazing unit 1 comprises a conventional glass inner pane 3 that is joined to an electrochromic outer pane 6 via a conventional edge seal 4 with a spacer 4a and a sealing profile 4b, forming an interpane space 5 (filled, for example, with a noble gas). The outer pane 6 is a composite pane system comprising two panes 6a, 6b, which, in turn, includes a suitable edge seal 7. It should be noted that the edge seal structures 4a/4b and 7 are depicted here only schematically and in a simplified manner. In addition, in FIG. 1, the inner structure of the outer pane 6 responsible for the electrochromic effect is not shown; this is known to the person skilled in the art.

The panes 6a, 6b of the electrochromic outer pane 6 have, on their interior side, transparent conductive coatings (surface electrodes—not shown), which can be connected to a control unit via a supply line 8. As explained above, but also not shown in the figure, bus bars for the solder connection to the connection line 8 are provided on the surface electrodes of the panes 6a, 6b.

FIG. 2 is a schematic representation of a somewhat differently constructed glazing unit 1′ according to the invention, which comprises a first glass pane 3 and second glass pane 6′, which are joined to one another and sealed by an edge seal 4′ forming an interior space 5. Here again, the edge seal 4′ is depicted in a simplified manner and comprises, as shown, a spacer 4a′ and, on each side thereof, on the surfaces adjacent the panes 3 and 6′, a respective polyisobutylene (PIB) sealing strip 4b′.

In order to realize an electro-optical effect with the glazing unit 1′, not to be further explained here, the inner surface of the second glass pane 6′ is provided with a transparent conductive coating (surface electrode, TCO) 9. A bus bar 10 is applied to the surface electrode 9 in the edge region of the glass pane 6′, but at a distance from its edge and to the inside of the edge seal 4′. The bus bar 10 is formed by dispensing a silver conductive paste and subsequent baking or sintering of this conductive paste in a manner known per se and contoured without sharp edges due to its manufacturing conditions.

The bus bar 10 is covered with an opaque covering 11, realized, for example, as an adhesive tape or paint application, which reaches here directly to the adjacent edge of the glass pane 6′. The coating 11 thus also covers the region where the sealing strip 4b′ abuts the glass pane 6′ and must, consequently, be made of a material that is compatible with the PIB of the sealing strip 4b′ and ensures long-term reliability of the edge seal. In the example depicted, the edge region of the glazing unit 1′ is also provided on the outer side of the second glass pane 6′ with a coating as an outer covering 12 that covers both the edge seal 4′ and the bus bar 10 and thus visually conceals both from the outer side of the glazing unit 1′.

As an alternative to the configuration depicted, the covering can also end at the inner edge of the PIB sealing strip 4b′, i.e., basically only that strip of the outer pane 6′ in which the bus bar 10 extends longitudinally can be covered. This eliminates the need to ensure compatibility between the material of the covering and the PIB of the sealing strip, and the reliability of the edge seal is certainly not adversely affected by the covering. Furthermore, it is possible to apply the covering slightly overlappingly with the PI B sealing strip.

### REFERENCE CHARACTERS

1; 1′ glazing unit
2 frame
3 inner pane (first pane)
4; 4′ edge seal
4a; 4a′ spacer
4b; 4b′ seal/sealing strip
pane interior
6; 6′ outerpane (second pane)
7 edge seal of the outer pane
8 connection line
9 transparent conductive coating (TCO)
bus bar
11 covering of the bus bar
12 outer covering

1. Glazing unit comprising first and second glass or plastic panes that are joined to one another at a predetermined distance via a spacer or a thermoplastic intermediate layer,
wherein at least one of the first and second glass or plastic pane includes, on an inner side of the glazing unit, a transparent electrically conductive coating and, in an edge region thereof, a bus bar for an electrical connection of the transparent electrically conductive coating,
wherein the bus bar is provided, at least over a greater part of its surface, with an opaque covering.

2. The glazing unit according to claim 1, wherein the bus bar is elongated and is arranged at or near an edge of the at least one of the first and second glass or plastic panes and extends parallel to the edge, and the opaque covering extends over an entire length of the edge.

3. The glazing unit according to claim 1, wherein the bus bar is arranged at a distance from the edge of the at least one of the first and second glass or plastic panes and the opaque covering extends all the way to the edge of the at least one of the first and second glass or plastic panes.

4. The glazing unit according to claim 1, wherein the opaque covering comprises an adhesive tape or a paint or lacquer layer.

5. The glazing unit according to claim 1, wherein the first and second glass or plastic pane are joined to one another and kept at a distance by an edge spacer device with a spacer element and, in each case, a sealing strip between the spacer element and the first and second glass or plastic pane, and the bus bar is arranged to an inside of the spacer device.

6. The glazing unit according to claim 5,
wherein the opaque covering covers a pane portion that contacts one of the sealing strips, and the opaque covering is made of a material compatible with the material of the sealing strip.

7. The glazing unit according to claim 1, implemented as a building glazing unit with electrically controllable properties or with a heatable glass or plastic pane.

8. The glazing unit according to claim 1, implemented as a composite vehicle pane with electrically controllable properties.

9. The glazing unit according to claim 1, implemented as an electrically heatable composite vehicle pane.

10. The glazing unit according to claim 1, implemented as a device glazing unit of a household appliance or a piece of furniture, with electrically controllable optical properties, or implemented as a heatable device glazing unit of a household appliance or piece of furniture.

11. The glazing unit according to claim 7, having electrochromic properties.

12. The glazing unit according to claim 1, wherein the opaque covering is electrically nonconductive.

13. Method for producing a glazing unit according to claim 1, comprising:
providing a first and a second glass or plastic pane, wherein at least one of the first and second glass or plastic panes includes, on one side, a transparent electrically conductive coating,
producing or applying a bus bar on the transparent electrically conductive coating in the edge region thereof,
attaching a supply line to the bus bar,
the providing a greater part of a surface of the bus bar with an electrically nonconductive, opaque covering.

14. The method according to claim 13 for producing a glazing unit,
wherein after providing the at least one of the first and second glass or plastic panes with a transparent electrically transparent electrically conductive coating, the bus bar is produced or applied on the transparent electrically conductive coating, and a supply line is soldered or conductively bonded onto the latter, and, subsequently, the bus bar is provided with the opaque covering with simultaneous covering of a soldering or bonding point.

15. The method according to claim 13 for producing a glazing unit,
wherein after providing the at least one of the first and second glass or plastic panes with a transparent electrically conductive coating, the bus bar is produced or applied on the transparent electrically conductive coating, the bus bar is subsequently provided with the opaque covering leaving open an intended soldering or bonding point, and, thereafter, a supply line is soldered or conductively bonded onto the bus bar at the soldering or bonding point.

16. The glazing unit according to claim 8, wherein the composite vehicle pane is a roof glazing or a windshield of a passenger car.

17. The glazing unit according to claim 9, wherein the electrically heatable composite vehicle pane is a roof glazing or a windshield of a passenger car.
